(19) United States
(12) Patent Application Publication
(10) Pub. No.: US 2007/0094118 A1
(43) Pub. Date: Apr. 26, 2007

(54) Exposure management system and method

(76) Inventors: Elke Becker, Reilingen (DE); Ulrich Haenle, Walldorf (DE); Joergen Jensen, Heidelberg (DE); Reinhold Loevenich, Sandhausen (DE); Klaus G. Mueller, Neustadt a.d. Weinstrasse (DE); Stefan Schmid, Wiesloch (DE)

Correspondence Address: KENYON & KENYON LLP, ONE BROADWAY, NEW YORK, NY, 10004, US

(21) Appl. No.: 11/255,335

(22) Filed: Oct. 21, 2005

(51) Int. Cl. G06Q 40/00

(52) U.S. Cl. 705/36 R; 705/38

(57) ABSTRACT

In a risk exposure system and method, a processor may receive from an external system exposure records having data elements mapped to data elements of an internal representation of an exposure record. The system and method may generate new exposure data objects based on the mapped data, automatically assign exposure data objects to exposures versions, and automatically assign exposure data objects of versions to exposure groups based on criteria defined by planning profiles. Further, the system and method may automatically generate for an exposure group and transmit to a marketplace an electronic purchase order requesting a hedging instrument to offset risk presented by the exposure group and identifying the exposure group, and, responsive to a transaction confirmation message that is received from the marketplace and that identifies the exposure group or purchase order, generate a hedging instrument data object and associate it with the exposure group.

### BACKGROUND

Business entities, e.g., banks, enter into a large number of transactions in the ordinary course of their operations. Some of these transactions carry financial risk. For example, individual loans carry the risk of debtor default, currency exchange rate fluctuations, or changing interest rates for variable rate loans or imminently mature loans (whose principal likely will be reinvested at a new interest rate). Typically, the business entities' internal policies or banking regulations of governing regulatory bodies, e.g., the International Accounting Standards Board (IASB), which has promulgated the International Accounting Standard (IAS) 39, Financial Instruments: Recognition and Measurement, or the Financial Accounting Standards Board (FASB), which has promulgated the Financial Accounting Statement (FAS) 133, Accounting for Derivative Instruments and Hedging Activities, require, at least in some instances, that the business entities own instruments, typically derivatives such as options, whose behavior counterbalances risks presented by the transactions. This is called “hedging.”

Risk exposures presented by a first, typically numerically large, set of instruments are counterbalanced by performance of a second, typically much smaller, set of instruments (called “hedging instruments” herein), such that when risk rises with respect to the instruments that present the risk exposures, risk falls in the hedging instruments. For example, a set of instruments are grouped and treated as a single exposure that is to be hedged. One or more hedging instruments counterbalance the exposure group. The exposures or exposure groups and their corresponding hedging instruments are grouped into corresponding hedging relationships. A hedging relationship associates one or more particular hedging instruments with a particular exposure or exposure group. Accordingly, use of hedging relationships aids in management of risk exposures and corresponding hedging instruments and facilitates compliance with hedging policies or regulations.

Hedging policies or regulations often require that certain exposures be hedged separately, for example, by different hedging instruments, and/or require or allow for grouping of certain exposures into a single group to be hedged by a common hedging instrument or common group of hedging instruments. For example, a business entity often includes numerous departments and/or is often a parent company that has multiple subsidiaries. It is often the case that each or some of the departments and/or subsidiaries individually enter into transactions that create an exposure to risk that is required to be offset by hedging instruments. In some instances, it is left to a central treasury department of the business entity and/or to the parent company to acquire hedging instruments to offset the risk created by transactions of the individual departments and or subsidiaries. In this instance, hedging policies or regulations may require that the central treasury department and/or parent company separately hedge against risk of exposures of the individual or certain of the individual departments or subsidiaries.

Conventional computer applications aid in the organization and management of a business entity's risk exposures, hedging instruments, and hedging relationships, and generate hedge accounting data, e.g., indicating to what extent the risk of the exposure or exposure group of the hedging relationship is offset by the hedging instrument(s) of the hedging relationship. However, such conventional hedging systems do not provide for automatic grouping of exposures. Furthermore, it is often the case that the central treasury department and/or parent company and the other departments (non-central treasury departments) and/or the subsidiaries do not share the same system. Instead, the non-central treasury departments and/or subsidiaries keep track of their individual transactions via separate systems. For the central treasury department and/or the parent company to manage the exposures of the individual transactions and to determine the hedging instruments that must be acquired by using the conventional hedging systems, the data regarding the individual transactions that is already entered into the separate systems of the non-central treasury departments and/or subsidiary companies must be manually entered into the hedging system of the central treasury department and/or parent company.

Conventional hedging systems also provide for associating hedging instruments with an exposure or exposure group via a hedging relationship data object, but require manual entry of data to associate the hedging instruments with the exposure or exposure group.

### BRIEF DESCRIPTION OF THE DRAWINGS

FIG. 1 is a block diagram that illustrates example components of a system, according to an example embodiment of the present invention.

FIG. 2 is a flowchart that illustrates an example procedure that may be performed for generation and management of exposure data objects.

FIG. 3 is a screenshot of an example display via which a user may manage data of exposure data objects.

FIG. 4 is a flowchart that illustrates an example procedure that may be performed for automatic association of hedging instruments to exposures or exposure groups.

### DETAILED DESCRIPTION

Embodiments of the present invention relate to a risk exposure management computer system and method that may provide for automatic generation of exposure data objects based on exposure data received from external systems. Embodiments of the present invention relate to a computer system and method that may automatically assign exposures to corresponding exposure groups. Embodiments of the present invention relate to the automatic generation of a request for a hedging instrument and the automatic association of a purchased hedging instrument with an exposure or exposure group for which it was purchased. The computer system may include a computer program written in any conventional computer language, and in particular in an object oriented computer language. Example computer languages that may be used to implement the computer system and method of the present invention may be Java, Extensible Markup Language (XML), C++, or a combination thereof.

### System Overview

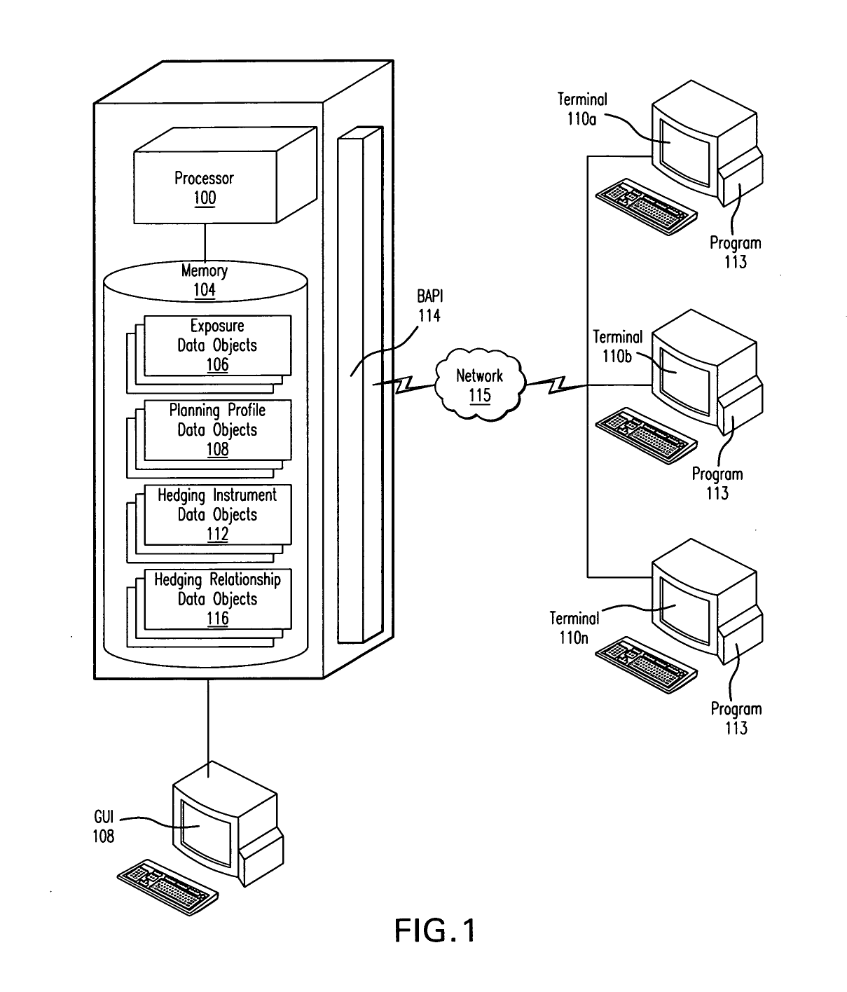

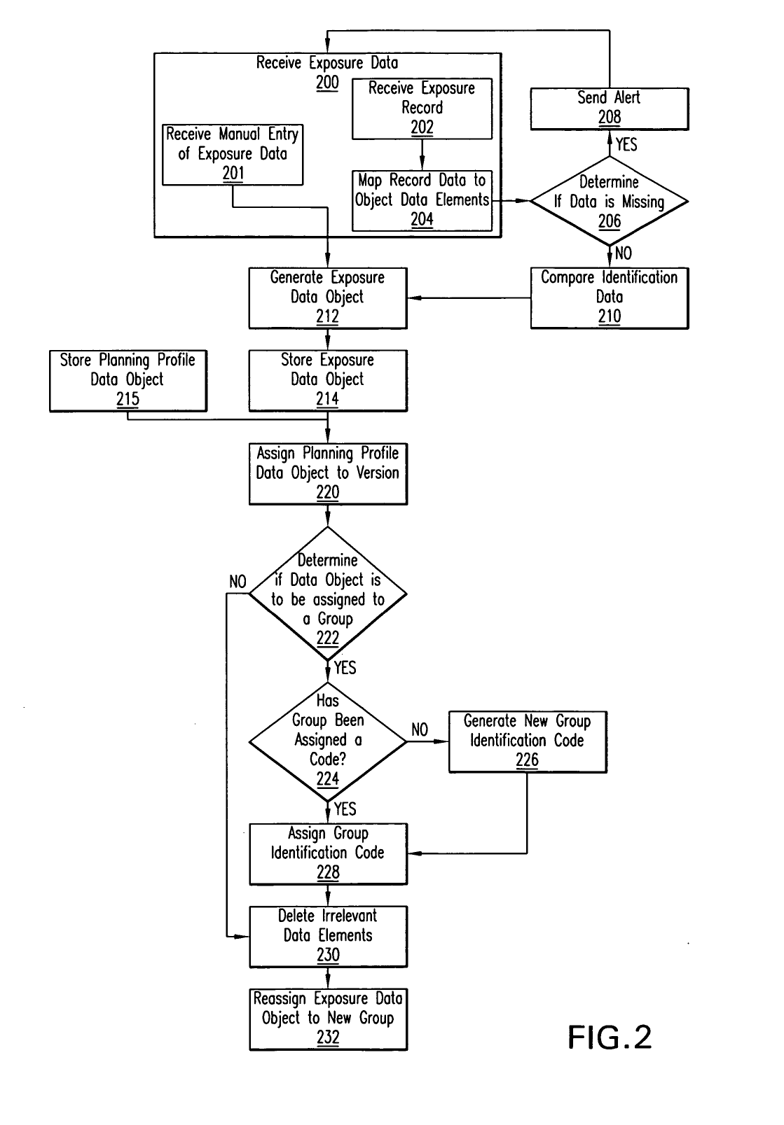

FIG. 1 is a block diagram that illustrates components of a risk exposure management system according to an example embodiment of the present invention. FIG. 2 is a flowchart that illustrates an example procedure that may be executed with the components illustrated in FIG. 1. A processor 100 may receive at 200 input of exposure data. As shall be discussed below, the exposure data may be inputted in one of two possible ways. At 212, the processor 100 may generate an exposure data object 106 based on the received exposure data and, at 214, store the exposure data object 106 in a memory 104. An exposure data object 106 may include predefined data elements, e.g., an amount including a +/− sign; a currency, e.g., USD, Euro, etc.; a period, e.g., day, month, quarter, etc., for which the risk exposure is determined; a due date at which time the transaction that causes the risk exposure is set to expire; a country, e.g., where the transaction took place or of the parties engaged in the transaction; a company and/or department code; and/or a comment field. The risk exposure management system may provide for data elements of the exposure data object that are not assigned to any particular data type, and may be customizable by a user. In generating an exposure data object 106, the processor 100 may obtain data corresponding to each or some of the data elements from the received exposure data. If the received exposure data does not include data corresponding to one or more predefined data elements, the exposure data object 106 may be generated without those one or more predefined data elements, e.g., if those one or more predefined data elements are not designated as required data elements.

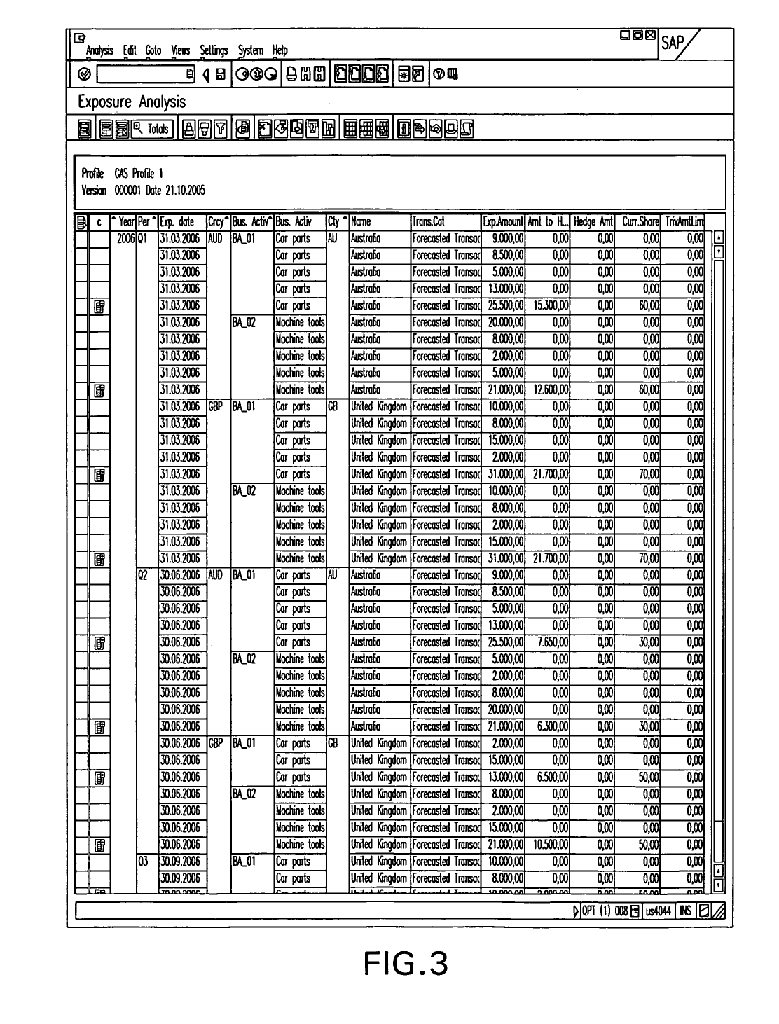

Receipt of the exposure data at 200 may be, e.g., in one of two ways. The processor 100 may, at 210, receive the exposure data input from a user who manually enters the individual data elements of the exposure data when logged into the risk exposure management system. For example, the risk exposure management system may provide data for generating a display, e.g., as shown, in FIG. 3, at a graphical user interface (GUI) 108, via which the user may input data elements for a new exposure data object to be generated by the processor 100 in response to the user input (or for updating data of an already generated data object).

The processor 100 may also receive, at 202-204, exposure data uploaded to the risk exposure management system from external systems. The external systems may be, e.g., any spreadsheet software, such as MS Excel. The risk exposure management system may be run, e.g., at a central treasury department of a company and/or at a parent company, while the external systems may be run, e.g., at terminals 110a-n at one or more non-central departments and/or at subsidiaries. The terminals 110 may be in communication with the risk exposure management system via a network 115, for example using a conventional browser application. Any conventional network may be used, e.g., the Internet. A user may enter exposure risk data into an external system via a terminal 110. Via the browser, the user may call a Business Application Programming Interface (BAPI) 114, i.e., an interface to the risk exposure management system. At the terminals 110a-n may be installed a program 113 which may be customized for each individual external system and/or for particular users of the external systems. The customizing may be for mapping particular data elements of an exposure record of an external system to the BAPI's corresponding representation of the data. For example, a user may customize the locally stored BAPI calling program 113 to map particular cells in Excel to particular data elements of an exposure data object template, e.g., an exposure data object class in an object oriented system. Accordingly, when the BAPI 114 is called, the BAPI calling program 113 may, at 202, map data elements of the exposure record to a corresponding representation of the data in the risk exposure management system. Accordingly, even if exposure record data of a plurality of external systems are represented in different ways, the BAPI 114 may provide for a uniform representation of the data by the processor 100 as an exposure data object 106, once imported into the risk exposure management system. At 204, the risk exposure management system may receive the mapped exposure record from the external system via the called BAPI 114. It will be appreciated that more than one exposure record may be uploaded during a single batch process.

After the BAPI 114 is called, the processor 100 may, at 212, automatically generate a new exposure data object(s) 106 based on the uploaded data. For example, in an object oriented system, the processor 100 may instantiate the exposure data object class to generate the new exposure data object 106. If it is determined at 206 that data corresponding to data elements designated as required is missing, the BAPI 114 may, at 208, output a message to be displayed at the terminal 110 alerting the user to the missing data. In an alternative embodiment, the program 113 may perform 206-208 before transmitting the exposure record to the risk exposure management system. In order for a new exposure data object 106 to be generated based on the received exposure record, it may be required for new exposure data to be received, i.e., for 200 to be repeated. For example, the user may enter additional data at a terminal 110 to modify the exposure record in the external system and re-upload the record to the risk exposure management system. Alternatively, the user may enter data for a new exposure record or modify data of the uploaded exposure record directly in the risk exposure management system.

Required data may be, e.g., a unique identification code associated with the uploaded exposure record. This may be required to ensure that a particular exposure record is not stored as two or more different exposure data objects. For example, if a unique identification is not provided, then if a particular exposure record is uploaded twice, the processor 100 may store two exposure data objects 106 in the memory 104 that both correspond to the same particular exposure record.

It may occur that different ones of the business entity's departments and/or subsidiaries assign to their respective exposure records the same identification code. It may occur that even a particular department of a particular subsidiary uses multiple systems, e.g., for recording transactions that concern different business ventures. For example, transactions concerning sales may be recorded in a first system, and transactions concerning purchases of machinery for manufacturing may be recorded in a second system. It may occur that identification codes are separately assigned to exposure records of the different systems, so that exposure records of the different systems may be assigned the same identification code. Accordingly, for uniquely identifying exposure records, with each uploaded exposure record, additional data may be required, e.g., a company code and/or a system code. In one embodiment of the present invention, which, if any, data elements are designated as required may be customizable for a particular business entity. For example, for a business entity that uses only one external system, a system code may be designated as an optional data element, and for a business entity that uses multiple systems, a system code may be designated as a required data element.

In an embodiment of the present invention, when the risk exposure management system receives an exposure record from an external system, the processor 100 may, at 210, compare identification data of the received exposure record to identification data of previously stored exposure data objects 106, to determine if the received exposure data record corresponds to a previously stored exposure data object 106. If the processor 100 determines that the received exposure record's identification data matches the identification data of a previously stored exposure data object 106, and that the received exposure record therefore corresponds to the previously stored exposure data object 106, the processor 100 may, at 214, overwrite the previously stored exposure data object 106.

Entering exposure records at a terminal 110 and/or uploading the exposure records to the exposure management system may be performed at any time. This may ensure that the external systems (terminals 110a-n) stay independent from the exposure management system. For example, while the business entity may find it useful to set deadlines for the subsidiaries and/or departments to upload their data into the exposure management system, from a technical standpoint, entry and upload may be performed at any time.

In an embodiment of the present invention, after generation and storage of exposure data objects, analysis may be performed, e.g., to determine the business entity's hedging requirements, such as the number and type of hedging instruments the business entity should acquire. The particular exposure data objects 106 stored in the memory 104, and, for a particular stored exposure data object 106, the particular data of the exposure data object 106, may vary over time. For example, new exposure data objects 106 may be constantly generated and stored. With respect to a particular exposure data object 106, after some time, the risk may pass, e.g., where an underlying transaction has completed. Accordingly, exposure analysis may produce different results depending on when it is performed, which may cause confusion. Accordingly, prior to analysis, a version of the exposure management system may be generated, referred to herein as an exposures version. An exposures version is a snapshot of the system at a particular time. Analysis may be performed for a version, rather than for a current state of the system. Over time multiple versions may be generated and stored. Any further analysis and processing may be done on the basis of a particular version. By taking versions of exposures, the following may be achieved:
decoupling of the uploading/entering of exposures and subsequent analysis and processing, and
creating a history of changes in exposures for auditing purposes.

A history may indicate which exposure data objects 106 were assigned to a particular planning profile (described in detail below) and/or exposure group (described in detail below) at recorded times. The history may include saved exposure analysis reports. In one embodiment of the present invention, the processor 100 may, e.g., in response to a user instruction, generate a report showing changes over time. For example, if an exposure data object 106 is removed from an exposure group, the report may list the deleted exposure data object 106 with a mark indicating that it has been deleted. In one embodiment, the report may be restricted to particular planning profiles selected by the user.

### Grouping Exposure Data Objects

It may be desirable to associate certain properties with a version. For example, the user might not want all stored exposure data objects 106 to be part of every version. For example, the number of exposure data objects 106 may become very large, so that analysis of only a subset thereof may be desirable. Another example, is that it may be desirable for an analysis to be performed separately for exposure data objects 106 that are of different risk categories, e.g., an interest rate risk category and a foreign exchange risk category. Furthermore, it may be desirable for an exposure analysis to be performed according to different hedge policies, as shall be discussed in detail below. It may also be desirable to group exposure data objects 106 into exposure groups (which shall be described in detail below) according to different criteria, and to perform an exposure analysis for the groupings according to the different criteria. In an embodiment of the present invention, planning profiles may be defined, e.g., by a user. When the user enters data for defining a hedge plan, the processor 100 may, at 215, store a corresponding planning profile data object 110. Definition of a planning profile and/or storage of a planning profile data object 110 may be performed before or after receipt of exposure data. Accordingly, in FIG. 2, 215 is shown in parallel to 200-214. When instructing the processor 100 to generate a version for performance of an exposure analysis, the user may associate a particular planning profile with the version. Accordingly, at 220, a particular planning profile data object 108 may be assigned to a version.

A planning profile may specify particular data elements, and/or determinations that may be made based on data elements, of the exposure data objects 106, and particular values or value ranges thereof to be used as a filter. For example, if an amount sign (+/−) is specified, it may correspond to a determination that may be made about an exposure data object 106 based on the amount element of the data object 106. The specified criteria may be used for determining which exposure data objects 106 are to be included in the version.

Typical planning profile criteria may be an exposure period, a year, a company code, a country, a sign (+/−), and/or a currency. The sign may be significant, since a negative sign of an amount data element of an exposure data object 106 may indicate a high probability that the exposure data object 106 relates to the business entity's production (an expense), and a positive sign may indicate a high probability that the exposure data object 106 relates to the business entity's receivables (income), and it may desirable to separately track these different aspect of the business entity's transactions. Maximum age of an exposure may be another example profile criterion. For example the user might create new versions referring to the same profile every month. A particular exposure might always be part of each version. As time goes by, the exposure does not correspond to an event in the future, but in the past. In that case it becomes obsolete for any analysis or processing, because the nature of hedging is to take care of risks, which implies to take care of future events. Therefore the user might want the exposure not to appear in a new version, if it has reached a certain age, i.e. after it has become history. In one example embodiment of the present invention, the processor 100 may determine an age of an exposure data object 106 based on a year data element (or other date/time data element) of the exposure data object 106. Additionally, the risk exposure management system may provide for undefined criteria that may be customizable by a user.

Hedging policies may also be associated with a planning profile. This Would reduce user interaction during an analysis of exposure data objects 106 in version, because desired hedge ratios would be specified by the planning profile. For example, a first policy with which a first profile is associated may provide that hedging instruments are to be acquired to offset 50% of an exposure's risk, while a second rule set with which a second profile is associated may provide that hedging instruments are to be acquired to offset 40% of an exposure's risk. Another example is where policies require hedging instruments to be acquired to offset an exposure's risk only if the risk amount exceeds a certain minimum, and where different ones of the policies provide for different minimums. In one exemplary embodiment, policies may be stored as independent data objects with which one or more planning profiles may be associated, for example, by use of pointers or any other conventional manner of association of data objects stored in a memory. In an alternative exemplary embodiment, each profile data object 108 may itself include data defining the rule set with which it is associated.

Grouping exposure data objects 106 within a version into one or more groups may be desirable, e.g., in order to calculate hedging data for the exposure data objects 106 of the group in combination. For example, a number and type of hedging instruments a business entity is to obtain to hedge against risk represented by the exposure data objects 106 may depend on how the exposure data objects 106 are grouped. An instance of this dependency may be, e.g., where a particular hedging policy applied to a plurality of exposure data objects 106 provides that a hedging instrument is to be acquired to offset the risk represented by the plurality of exposure data objects 106 only if the risk exceeds a certain minimum amount. In this instance, if the minimum amount is, for example, 99 U.S. dollars, and a risk of each of two exposure data objects 106 is, for example, 50 U.S. dollars, then it may be determined that the business entity need not acquire a hedging instrument to offset the risk of either of the two exposure data objects 106. If, however, the two exposure data objects 106 are grouped together and the same hedging policy is applied to the exposure group, instead of to the exposure data objects 106 individually, then it may be determined that the business entity should acquire one or more hedging instruments to offset the risk represented by the exposure group, since the combined risk amount of 100 U.S. dollars exceeds the policy's minimum amount.

In an embodiment of the present invention, the processor 100 may assign one or more exposure data objects 106 within a version to a corresponding exposure group. For example, the processor 100 may determine which exposure data objects 106, if any, are to be grouped. If the processor 100 determines that particular exposure data objects 106 are to be grouped, the processor 100 may assign to each of the particular exposure data objects 106 a same group identification code. For example, the exposure data objects 106 may include a group identification code data element. After the processor 100 stores the exposure data object in the memory 104, the processor 100 may, at 222, determine if the data object 106 is to be assigned to an exposure group. As shall be more fully described below, it is noted that 222 et seq. need not be performed in response to generation and storage of an exposure data object 106, but may instead be performed, e.g., in response to an instruction to perform an analysis or in response to an instruction to generate a version. If it is determined that the exposure data object 106 is to de assigned to an exposure group, the processor 100 may, at 228, populate the group identification code data element with the determined group's identification code in order to assign the exposure data object 106 to the group.

It may occur that, at 222, the processor 100 determines that the exposure data object 106 should be grouped with one or more other exposure data objects 106, which have not yet been assigned a group identification code. At 224, the processor 100 may determine if a group identification code has been assigned to the group to which the exposure data objects 106 is to be assigned. If the processor 100 determines that a group identification code has not been assigned, i.e., that a new group should be formed, the processor 100 may, at 226, generate a new group identification code for the exposure data objects 106 that are to form the new group. Alternatively, a table may be stored that identifies each or some exposure data objects 106 and corresponding group identification codes. Any conventional manner of grouping data elements may be used. In response to a determination that a new exposure data object 106 is to be assigned to a newly formed group, the processor 100 may assign to the new group all of the exposure data objects 106 that are to form the new group.

The processor 100 may determine which exposure data objects 106 are to be grouped based on particular data elements of the exposure data objects 106. For example, if the particular data elements of two or more exposure data objects 106 match, the processor 100 may determine that they are to be grouped. In one example embodiment of the present invention, the data elements according to which exposure data objects 106 are grouped may be predetermined by the planning profile with respect to which the version was created. In an alternative embodiment, versioning and planning profiles may be omitted. Instead, grouping criteria may be entered and stored in the memory 104 for direct application to all exposure data objects 106. According to this latter embodiment, 215-220 may be omitted.

For example, a user may determine that all exposure data objects 106 having a same period should be analyzed according to a same rule set and may therefore instruct the processor 100 to group all of said exposure data objects 106 into a single hedge plan. The user may also determine that even if two or more exposure data objects 106 have the same period, they should be separately analyzed if their age is different by a particular amount. For example, the user may instruct the processor 100 to group into sub-groups exposure data objects 106 of a single hedge plan that match with respect to their year.

Example data elements or criteria based on data elements according to which exposure groups may be formed are the period data element, the country data element, the sign (+/−) data element, the company and/or department data element, the age of the exposure data object 106, or a combination of one or more of said data elements or criteria. Exposure data objects 106 of a single planning profile may be further divided into exposure groups according to any one of their data elements or any combination thereof, e.g., other than the particular criteria used for including the exposure data objects 106 into the version in the first place.

In an embodiment of the present invention, for versions referring to different planning profiles, different data elements and/or criteria may be used for dividing the exposure data objects 106 into groups. For example, aside from the particular rule set to be applied to its exposure data objects 106, a profile may define the data elements to be used for forming the groups. Accordingly, the result of the determination at 222 may be different for different profiles. Accordingly, according to the embodiment in which groups are formed for versions rather than directly applied criteria, the group ID may be a data element of an exposure data object 106 of a version (a particular copy of the exposure data object 106), rather than the originally generated and stored exposure data objects 106.

In one example embodiment, after an exposure data object 106 has become part of a version referring to a particular planning profile, the processor 100 may determine which data elements of the exposure data object 106 are relevant, e.g., for its assignment to a particular group and/or for performing an analysis regarding the exposure data object 106. The processor 100 may, at 230, delete from the memory 104 those data elements that are determined to be irrelevant, for example, in order to free memory space.

In an embodiment of the present invention, after the processor 100 assigns an exposure data object 106 to an exposure group for a first version of a particular planning profile, the processor 100 may, at 232, reassign the exposure data object 106 to a different exposure group for a second version of the planning profile. For example, the processor 100 may, at 232, reassign the exposure data object 106 to a different exposure group, e.g., if one or more data elements of the exposure data object 106 is changed. Reassignment at 232 may refer to repeating 222-230 for the same exposure data object 106, e.g., a version copy thereof, but for a different version. Alternatively, in an embodiment where versioning is not used, 232 may refer to actual reassignment of a same exposure data object 106 to a different exposure group. For example, a user at an external system from which the data based upon which the exposure data object 106 was generated may determine that the country information previously entered is incorrect. The user may therefore change this information and upload the modified exposure record to the risk exposure management system. As described in detail above, the previously generated and stored exposure data object 106 may be overwritten with data of a new exposure data object 106 having the new data. Based on the new data, for the second version, the processor 100 may determine that the modified exposure data object 106 is to be assigned to an exposure group different than the one to which the exposure data object 106 was previously assigned.

In an embodiment of the present invention, the processor 100 may include an exposure data object 106 in a first version associated with a particular planning profile but not in a second version associated with the particular planning profile because of changes made to data elements of the exposure data object 106 that are relevant to the determination of the planning profiles to which the exposure data object 106 may be assigned. Implementation of such changes is more fully described above. In an embodiment of the present invention, a planning profile and/or the policy with which it is associated may be changed, e.g., by user redefinition. In response to changes to a hedge plan and/or to the rule set with which it is associated, different exposure data objects 106 may be assigned to a new version associated with the planning profile than those exposure data objects 106 that had been assigned to a first version associated with the planning profile. An example may be where a policy of a planning profile is changed so that it is to be applied to only exposure data objects 106 that represent long term risk, instead of to only exposure data objects 106 that represent short term risk.

In an embodiment of the present invention, generation of a new version and/or group assignment changes in an embodiment that does not provide for versioning may be implemented, e.g., at one or more of the following times: in response to a rule set change; in response to an exposure data object 106 change; in response to receipt of new exposure data objects 106; in response to an instruction, for example, by a user, to implement changes if it is determined that changes are required; and/or approximately immediately prior to an exposure analysis. It will be appreciated that these times are provided by way of example only.

In an embodiment of the present invention, at predetermined times and/or in response to a user instruction, the processor 100 may perform an exposure analysis for each exposure group (or for an individual exposure data object 106 if not assigned to any group) by applying to each exposure group a rule set, e.g., including a particular hedge policy, of a planning profile with reference to which the version was created. For example, for each exposure group, the processor 100 may add the amounts of the individual exposure data objects 106 assigned to the group, and may multiply the result by the percentage the rule set requires to be hedged against. The processor 100 may output, e.g., at the GUI 108, a report indicating the hedging instruments the business entity is required to purchase to hedge against the risk presented by the transactions underlying the exposure data objects 106.

In an embodiment of the present invention, the risk exposure management system may receive data representing hedging instruments procured by the business entity. In response thereto, the processor 100 may generate and store in the memory 104 corresponding hedging instrument data objects 112. Hedging relationship data objects 116 may be stored that associate particular hedging instrument data objects with particular exposure data objects 106, or to a particular exposure group. However, it may be required for the management of receipt, grouping, and analysis of exposure data objects 106 to be performed separately from the management of the hedging of the exposure data objects 106 and exposure groups. This may be required because the analysis may be conducted according to a plurality of versions and a plurality of planning profiles, where an exposure data objects 106 may be assigned to different exposure groups according to the different planning profiles. For purposes of hedging, however, it may be required for a single one of the exposure groups to which the exposure data object 106 is assigned to be selected. Hedging instruments may then be acquired for hedging against that single exposure group, rather than all conceptual exposure groups to which the single exposure data object 106 may be assigned.

Accordingly, exposure data objects 106 (not assigned to any group) and particular exposure groups may be selected for transference to or copying to a separate hedging portion of the exposure management system. The hedging relationship data objects 116 and hedging instrument data objects 112 may be associated with the hedging portion of the system, and may be associated with the transferred or copied exposure data objects 106 or exposure groups.

Referring back to the analysis portion of the system, the processor 100 may determine the extent to which the risk represented by the exposure data objects 106 of a particular exposure group that corresponds to a group in the hedging portion of the system is offset by the hedging instruments with which they are associated. The analysis output may reflect a remaining risk amount for which the business entity is required to purchase additional hedging instruments.

### Purchase of Hedging Instruments

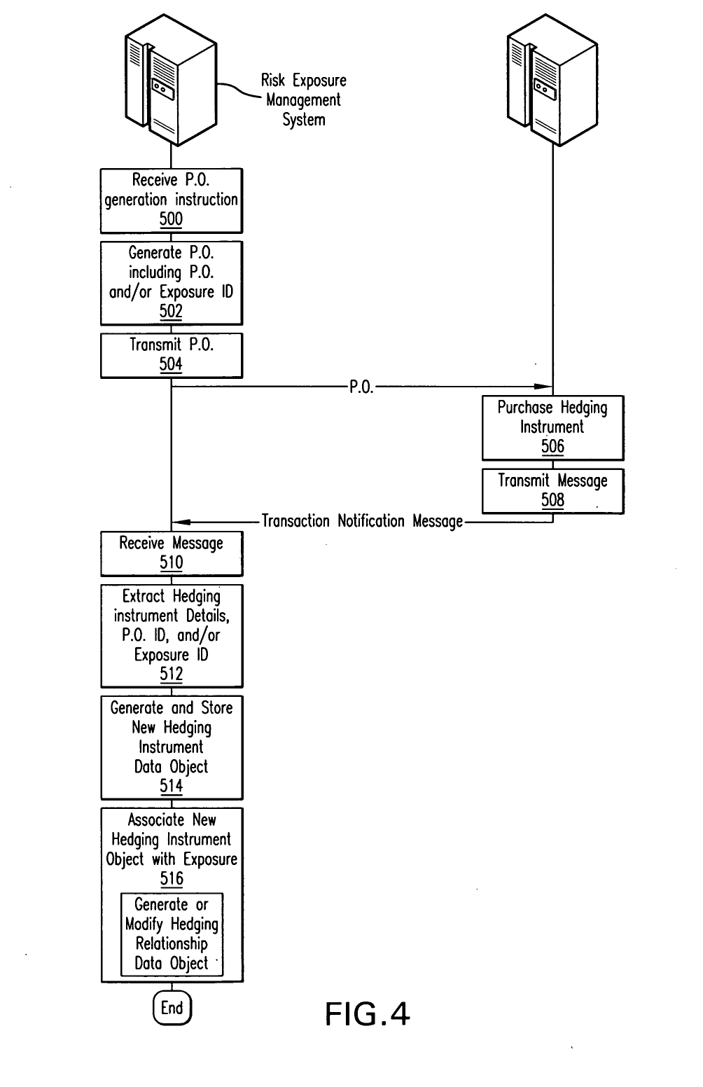

FIG. 4 is a flowchart that illustrates an example procedure that may be performed for automatic association of hedging instruments to exposures in the hedging portion of the system. In an embodiment of the present invention, for a particular exposure data object 106, e.g., that is not assigned to an exposure group, or for a particular exposure group, the processor 100 may automatically generate, at 502, an electronic purchase order (P.O) for one or more hedging instruments to offset the risk presented by the transaction(s) of the particular exposure data object 106 or exposure group. For example, the processor 100 may provide data for generating an interactive display, e.g., at the GUI 108, for viewing data of an exposure data object 106 or an exposure group. The user may determine that a hedging instrument should be purchased for a particular exposure data object 106 or exposure group, for example, based on the report that is based on the exposure analysis. Via the interactive display, the user may input an instruction to order a hedging instrument for a selected exposure data object 2106 or exposure group. The processor 100 may, at 500, receive the instruction, and may, at 502, generate the P.O. in response to the instruction.

The P.O. may be in the form of, e.g., an XML message. Alternatively, it may be any form processable by both the risk exposure management system and an external system to which the P.O. is to be transmitted. In one example embodiment, the processor 100 may generate a conventional e-mail for transmission to an e-mail system at an address of a user at a marketplace. The processor 100 may associate each exposure data object 106 and/or exposure group with a unique ID. For example, with reference to FIG. 2, during the generation of the exposure data object 106 at 212, the processor may generate a unique ID for the exposure data object 106, which may be stored as a data element of the exposure data object 106. Assignment of exposure data objects 106 to exposure groups based on group identification codes has been described in detail above. The processor 100 may insert into the P.O., e.g., in the XML message, the ID of the exposure data object 106 or exposure group for which the P.O. is generated. Alternatively, when generating the P.O. at 502, the processor 100 may generate a unique P.O. ID, which the processor 100 may insert into the P.O. In one example embodiment, the risk exposure management system may provide for input of data by a user for indicating the particular hedging instrument or hedging instrument type to be requested. The P.O. may be generated according to the data input.

At 504, the processor 100 may transmit the generated P.O. to, e.g., an external system at a marketplace at which the requested hedging instruments may be purchased for the business entity for which the risk exposure management system transmitted the P.O. The P.O. may be transmitted using, e.g., Hyper Text Transfer Protocol (HTTP), Simple Mail Transfer Protocol (SMTP), or any other conventional transfer protocol. In one example embodiment, the risk exposure management system may provide for input of data by a user for indicating the particular marketplace to which the P.O. is to be transmitted.

At 506, a transaction may be executed, e.g., by a user of the external marketplace system, for the purchase of the requested hedging instrument. After the requested hedging instrument is purchased, a transaction notification message may be transmitted, at 508, from the external system to the risk exposure management system. The message may be in the same or a different format as that of the P.O. and may be sent using the same or different protocol as that used for transmitting the P.O., as long as the format and protocol is compatible with the risk exposure management system. The message from the external system may include details of the transaction and the ID of the P.O. for which the hedging instrument was purchased and/or the ID of the exposure data object 106 or exposure group for which the hedging instrument was purchased. The external system may be configured to be compatible with the risk exposure management system, e.g., so that the P.O. is processed as intended and so that a particular agreed upon format, protocol, and/or content is used for the generation and transmission of the transaction notification message.

At 510, the risk exposure management system may receive the transaction notification message. The processor 100 may be configured to, at 512, extract from the message received from the external system the details of the purchased hedging instrument, the P.O. ID, and/or the exposure data object 106 or exposure group ID. At 514, the processor 100 may generate and store a new hedging instrument data object 112 representing the purchased hedging instrument and may, at 516, associate it with the exposure data object 106 or exposure group for which the P.O. was generated and transmitted. For example, at 516, the processor 100 may generate a new hedging relationship data object 116 or modify a previously stored hedging relationship data object 116 associated with the exposure data object 106 or exposure group. The processor 100 may associate the new hedging instrument data object 112 with the generated or modified (due to the new association) hedging relationship data object 116. To associate the hedging instrument data object 112 with the hedging relationship data object 116, and to associate the hedging relationship data object 116 with the exposure data object 106 or exposure group, the processor 100 may store data, such as pointers or a table of data objects and their associations, or may associate them in any other any other conventional manner of associating data objects.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A risk exposure management method, comprising:
mapping at least one data element of an exposure record to a corresponding data element of an exposure data object template of a first system;
at the first system, receiving from a second system the mapped at least one data element; and
generating an exposure data object based on the exposure data object template and the mapped at least one data element.

2. The risk exposure management method of claim 1, further comprising:
automatically assigning a first plurality of exposure data objects to an exposure group based on at least one data element type of each of the first plurality of exposure data objects.

3. The risk exposure management method of claim 2, wherein the assignment of the first plurality of exposure data objects to the exposure group is for treating risk exposures represented by the first plurality of exposure data objects as a single risk exposure.

4. The risk exposure management method of claim 1, further comprising:
generating an exposures version associated with a planning profile;
based on at least one data element of the generated exposure data object, determining whether the generated exposure data object satisfies at least one criterion of the planning profile; and
automatically assigning the generated exposure data object to the version if it is determined that the exposure data object satisfies the at least one criterion.

5. The risk exposure management method of claim 4, wherein the planning profile is associated with a particular one of a plurality of hedging requirements.

6. The risk exposure management method of claim 5, wherein a first plurality of exposure data objects including the generated exposure data object is assigned to the version, the method further comprising:
based on at least one data element type of each of the first plurality of exposure data objects, determining whether any of the first plurality of exposure data objects should be assigned to a same exposure group; and
if it is determined that, of the first plurality of exposure data objects, a second plurality of the exposure data objects should be assigned to the same exposure group, automatically assigning each of the second plurality of exposure data objects to the same exposure group;
wherein risk exposures represented by exposure data objects of a single exposure group are hedged as a single risk exposure.

7. The risk exposure management method of claim 6, wherein for different planning profiles, different data element types are used for determining whether exposure data objects of the hedge plans should be assigned to an exposure group.

8. The exposure management method of claim 6, wherein the planning profile defines the at least one data element type that is to be used for determining whether any of the first plurality of exposure data objects should be assigned to the same exposure group.

9. An article of manufacture comprising a computer-readable medium having stored thereon instructions adapted to be executed by a processor, the instructions which, when executed, define a risk exposure management method, the method comprising:
mapping at least one data element of an exposure record to a corresponding data element of an exposure data object template of a first system;
at the first system, receiving from a second system the mapped at least one data element; and
generating an exposure data object based on the exposure data object template and the mapped at least one data element.

10. A risk exposure management system, comprising:
an arrangement configured to map at least one data element of an exposure record to a corresponding data element of an exposure data object template of a first system
an arrangement at the first system configured to receive from a second system the mapped at least one data element; and
an arrangement configured to generate an exposure data object based on the exposure data object template and the at least one mapped data element.

11. A risk exposure management method, comprising:
automatically assigning at least one exposure data object to an exposures version, wherein a planning profile associated with the version defines at least one criterion for determining whether exposure data objects of the version should be grouped into a single exposure group; and
automatically forming at least one exposure group based on the at least one criterion of the planning profile.

12. An article of manufacture comprising a computer-readable medium having stored thereon instructions adapted to be executed by a processor, the instructions which, when executed, define a risk exposure management method, the method comprising:
automatically assigning at least one exposure data object to an exposures version, wherein a planning profile associated with the version defines at least one criterion for determining whether exposure data objects of the version should be grouped into a single exposure group; and
automatically forming at least one exposure group based on the at least one criterion of the planning profile.

13. A risk exposure management system, comprising:
an arrangement configured to automatically assign at least one exposure data object to an exposures version, wherein planning profile associated with the version defines at least one criterion for determining whether exposure data objects of the version should be grouped into a single exposure group; and
an arrangement configured to automatically form at least one exposure group based on the at least one criterion of the planning profile.

14. A risk exposure management method, comprising:
for one of an exposure data object and an exposure group, automatically generating an electronic purchase order (P.O.) requesting a purchase of a hedging instrument, wherein the P.O. includes a unique identification of at least one of (a) the P.O. and (b) the one of the exposure data object and the exposure group;
transmitting the P.O. to a marketplace;
receiving from the marketplace a responsive transaction notification message including transaction details and a copy of the identification;
automatically generating a hedging instrument data object based on the transaction details;
based on the copy of the identification, determining that the hedging instrument data object is to be associated with the one of the exposure data object and the exposure group; and
storing data associating the hedging instrument data object with the one of the exposure data object and the exposure group.

15. An article of manufacture comprising a computer-readable medium having stored thereon instructions adapted to be executed by a processor, the instructions which, when executed, define a risk exposure management method, the method comprising:
for one of an exposure data object and an exposure group, automatically generating an electronic purchase order (P.O.) requesting a purchase of a hedging instrument, wherein the P.O. includes a unique identification of at least one of (a) the P.O. and (b) the one of the exposure data object and the exposure group;
transmitting the P.O. to a marketplace;
receiving from the marketplace a responsive transaction notification message including transaction details and a copy of the identification;
automatically generating a hedging instrument data object based on the transaction details;
based on the copy of the identification, determining that the hedging instrument data object is to be associated with the one of the exposure data object and the exposure group; and
storing data associating the hedging instrument data object with the one of the exposure data object and the exposure group.

16. A risk exposure management system, comprising:
an arrangement configured to automatically generate, for one of an exposure data object and an exposure group, an electronic purchase order (P.O.) that requests a purchase of a hedging instrument, wherein the P.O. includes a unique identification of at least one of (a) the P.O. and (b) the one of the exposure data object and the exposure group;
an arrangement configured to transmit the P.O. to a marketplace;
an arrangement configured to receive from the marketplace a responsive transaction notification message that includes transaction details and a copy of the identification;
an arrangement configured to automatically generate a hedging instrument data object based on the transaction details;
an arrangement configured to determine, based on the copy of the identification, that the hedging instrument data object is to be associated with the one of the exposure data object and the exposure group; and
an arrangement configured to store data that associates the hedging instrument data object with the one of the exposure data object and the exposure group.
